(19) United States
(12) Patent Application Publication
(10) Pub. No.: US 2010/0214307 A1
(43) Pub. Date: Aug. 26, 2010

(54) METHOD AND APPARATUS FOR EMBEDDING WATERMARK

(75) Inventors: Choong-hoon Lee, Seoul (KR); Jin-mok Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/509,685

(22) Filed: Jul. 27, 2009

(30) Foreign Application Priority Data
Feb. 20, 2009 (KR) 10-2009-0014427

(51) Int. Cl. G09G 5/00; H04N 1/40

(52) U.S. Cl. 345/581; 358/3.28

(57) ABSTRACT

Provided is a method and apparatus for embedding a watermark, the method including dividing an image into a plurality of sections, determining a watermark-embedding intensity for a pixel of each of the sections, setting a watermark-embedding intensity for each of the sections by applying the determined watermark-embedding intensity for the particular pixel of each of the sections to all pixels of each of the sections, and embedding the watermark into the image according to the watermark-embedding intensity which is set for each of the sections.

### CROSS-REFERENCE TO RELATED PATENT APPLICATION

This application claims priority from Korean Patent Application No. 10-2009-0014427, filed on Feb. 20, 2009, in the Korean Intellectual Property Office, the disclosure of which is incorporated herein in its entirety by reference.

### BACKGROUND OF THE INVENTION

1. Field of the Invention

Methods and apparatuses consistent with the present invention relate to digital watermarking an image, and more particularly, to embedding a watermark in which a watermark signal is embedded into an image signal according to a watermark-embedding intensity.

2. Description of the Related Art

A digital watermark is a technique for embedding a code such as an identification (ID) or information which can be perceived only by a user into digital content or embedding a particular code or pattern into an image or audio signal in order to prevent illegal copying and efficiently protect the copyrights and ownership of a data owner. The digital watermark is very effective to identify the source or copying path of original data without causing inconvenience to a user to view an image or use software.

In general, a watermark is embedded into original data by adding a watermark signal to the original data or multiplying the original data by the watermark signal.

For example, in an additive watermarking method which is a related art watermark embedding method, a watermark may be embedded into an image as follows:

Y=X+λW (1),

where X indicates an original image, W indicates a watermark signal, λ indicates a watermark-embedding intensity, and Y indicates a watermark-embedded image.

In the related art watermark embedding method, a watermark-embedding intensity for embedding a watermark into an image has to be calculated for each sample. As a result, the related art watermark embedding method requires a large amount of calculations for the watermark-embedding intensity, making it difficult to embed the watermark into the image on a real-time basis.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for embedding a watermark in which a watermark-embedding intensity of a watermark to be embedded into an image is controlled to reduce the time required for embedding the watermark.

According to an aspect of the present invention, there is provided a method of embedding a watermark, the method including dividing an image into a plurality of sections, determining a watermark-embedding intensity for a pixel of each of the sections, setting a watermark-embedding intensity for each of the sections by applying the determined watermark-embedding intensity for the particular pixel of each of the sections to all pixels of each of the sections, and embedding the watermark into the image according to the watermark-embedding intensity which is set for each of the sections.

According to another aspect of the present invention, there is a provided method of embedding a watermark, the method including transforming a spatial-domain image into frequency-domain image coefficients, dividing the frequency-domain image coefficients into sections, determining a watermark-embedding intensity for a particular transform coefficient of each of the sections, applying the determined watermark-embedding intensity for the particular transform coefficient to all transform coefficients of each of the sections, embedding the watermark into the frequency-domain image coefficients according to the determined watermark-embedding intensity, and transforming the frequency-domain image coefficients into the spatial-domain image.

According to another aspect of the present invention, there is a provided an apparatus for embedding a watermark, the apparatus including an image input unit which receives image into which the watermark is to be embedded, a watermark-embedding intensity determining unit which divides the image received by the image input unit into a plurality of sections, determines a watermark-embedding intensity for a particular pixel of each of the sections, and sets a watermark-embedding intensity for each of the sections by applying the determined watermark-embedding intensity for the particular pixel of each of the sections to all pixels of each of the sections, and a watermark embedding unit which embeds watermark data of which the embedding intensity is controlled according to the watermark-embedding intensity which is set for each of the sections by the watermark-embedding intensity determining unit into the image.

### BRIEF DESCRIPTION OF THE DRAWINGS

The above and/or other aspects of the present invention will become more apparent by describing in detail exemplary embodiments thereof with reference to the attached drawings in which:

FIG. 1 is a detailed block diagram of an apparatus for embedding a watermark according to an exemplary embodiment of the present invention;

FIG. 2 is a detailed block diagram of a watermark-embedding intensity determining unit shown in FIG. 1;

FIG. 3 is an image for explaining a basic concept of a method of embedding a watermark, according to an exemplary embodiment of the present invention;

FIG. 4 is a flowchart illustrating a method of embedding a watermark according to an exemplary embodiment of the present invention;

FIG. 5 is a detailed flowchart illustrating an operation of determining a watermark-embedding intensity, illustrated in FIG. 4;

FIG. 6 is a detailed flowchart illustrating an operation of calculating a watermark-embedding intensity for each section, illustrated in FIG. 5;

FIG. 7 is an image for explaining an operation of calculating a watermark-embedding intensity for each section, illustrated in FIG. 5;

FIG. 8 is a flowchart illustrating a method of embedding a watermark according to another exemplary embodiment of the present invention; and

FIG. 9 is a detailed flowchart illustrating an operation of determining a watermark-embedding intensity, illustrated in FIG. 8.

### DETAILED DESCRIPTION OF THE INVENTION

Hereinafter, exemplary embodiments of the present invention will be described with reference to the accompanying drawings.

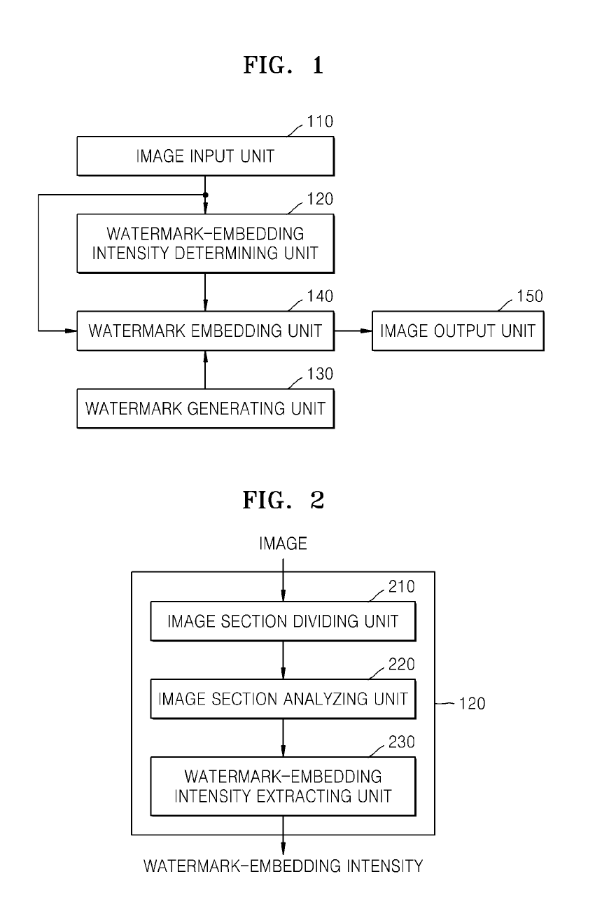

FIG. 1 is a detailed block diagram of an apparatus for embedding a watermark according to an exemplary embodiment of the present invention.

Referring to FIG. 1, the apparatus includes an image input unit 110, a watermark-embedding intensity determining unit 120, a watermark generating unit 130, a watermark embedding unit 140, and an image output unit 150.

The image input unit 110 receives an original image into which a watermark is to be embedded.

The watermark-embedding intensity determining unit 120 divides the image input through the image input unit 110 into predetermined sections, determines a watermark-embedding intensity for a particular pixel of each section by using the similarity between adjacent pixels, and determines the determined watermark-embedding intensity for the particular pixel of each section as a watermark-embedding intensity for every pixel of each section. The watermark-embedding intensity is also called a local weighting.

The watermark generating unit 130 determines a watermark pattern indicating information associated with an original image or reproduction thereof and converts the watermark pattern into an image data format, thereby generating watermark data. The watermark pattern is determined based on the information associated with the original image or reproduction thereof. For example, the watermark pattern may indicate information about an apparatus for generating watermark-embedding information, i.e., information about an identification ID of the apparatus and the reproduction time of the apparatus. In addition, the watermark pattern may be determined such that the watermark pattern includes information about a user who currently is reproducing the image. The watermark pattern may be generated as a random number sequence.

The watermark embedding unit 140 embeds the watermark data of which the embedding intensity is controlled according to the watermark-embedding intensity determined by the watermark-embedding intensity determining unit 120 into the image.

The image output unit 150 outputs an image signal into which the watermark data is embedded by the watermark embedding unit 140.

FIG. 2 is a detailed block diagram of the watermark-embedding intensity determining unit 120 illustrated in FIG. 1.

Referring to FIG. 2, the watermark-embedding intensity determining unit 120 includes an image section dividing unit 210, an image section analyzing unit 220, and a watermark-embedding intensity extracting unit 230.

The image section dividing unit 210 divides an input original image into predetermined sections.

The image section analyzing unit 220 analyzes image characteristics of each of the sections obtained by the image section dividing unit 210.

The watermark-embedding intensity extracting unit 230 extracts a watermark-embedding intensity for each section based on the image characteristics of each section analyzed by the image section analyzing unit 220 and the similarity between adjacent pixels. That is, the watermark-embedding intensity extracting unit 230 determines a watermark-embedding intensity for a particular pixel of each section as a watermark-embedding intensity for every pixel of each section based on the image characteristics of each section and similarity between adjacent pixels.

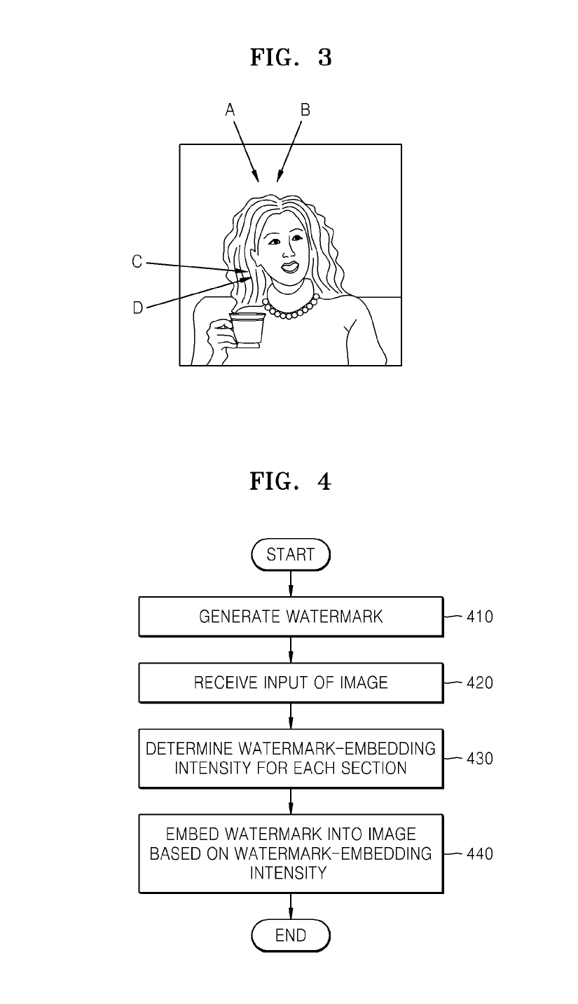

FIG. 3 is an image for explaining a basic concept of a method of embedding a watermark, according to an exemplary embodiment of the present invention.

Generally, in a still image or a moving image, pixels which are adjacent to each other or are located nearby to each other have very similar characteristics to each other. For example, two adjacent samples are highly likely to have similar color and brightness and the complexities of regions including these samples would also be similar.

In the image shown in FIG. 3, a pixel A and a pixel B, which are located near each other, both have intermediate levels of brightness, and surrounding regions of the pixel A and pixel B are not complex and are smooth. A pixel C and a pixel D, which are adjacent to each other, have low levels of brightness, and surrounding regions of the pixel C and pixel D are very complex.

The watermark-embedding intensity factor is a value used to improve the invisibility of a watermark by using the human visual perception ability which changes with the characteristics of an image. For example, in the image shown in FIG. 3, if a watermark is embedded into the adjacent pixels A and B and the adjacent pixels C and D, the watermark may be embedded with similar embedding intensities for the pixels A and B and for the pixels C and D. Thus, watermark-embedding intensities are calculated only in the positions of the pixel A and the pixel C and the watermark-embedding intensities calculated in the positions of the pixel A and the pixel C are applied as watermark-embedding intensities for the pixel B and the pixel D, respectively.

Therefore, in the exemplary embodiment, a watermark-embedding intensity corresponding to a local weighting for a watermark is controlled by applying a watermark-embedding intensity calculated for a particular pixel to another pixel adjacent to the particular pixel, instead of calculating a watermark-embedding intensity for each pixel.

FIG. 4 is a flowchart illustrating a method of embedding a watermark according to an exemplary embodiment of the present invention.

In operation 410, a watermark pattern indicating information associated with an image or reproduction thereof is determined and then the watermark partition is converted into an image data format, thereby generating watermark data.

An image into which a watermark is to be embedded is input in operation 420.

In operation 430, the input image is divided into predetermined sections and image characteristics of each section are analyzed to determine a watermark-embedding intensity for each section.

In operation 440, the watermark data is embedded into the image based on the determined watermark-embedding intensities.

Therefore, according to the exemplary embodiment, by applying a watermark-embedding intensity calculated for a particular pixel to another pixel adjacent to the particular pixel, watermark-embedding intensity calculation can be completed in a short time.

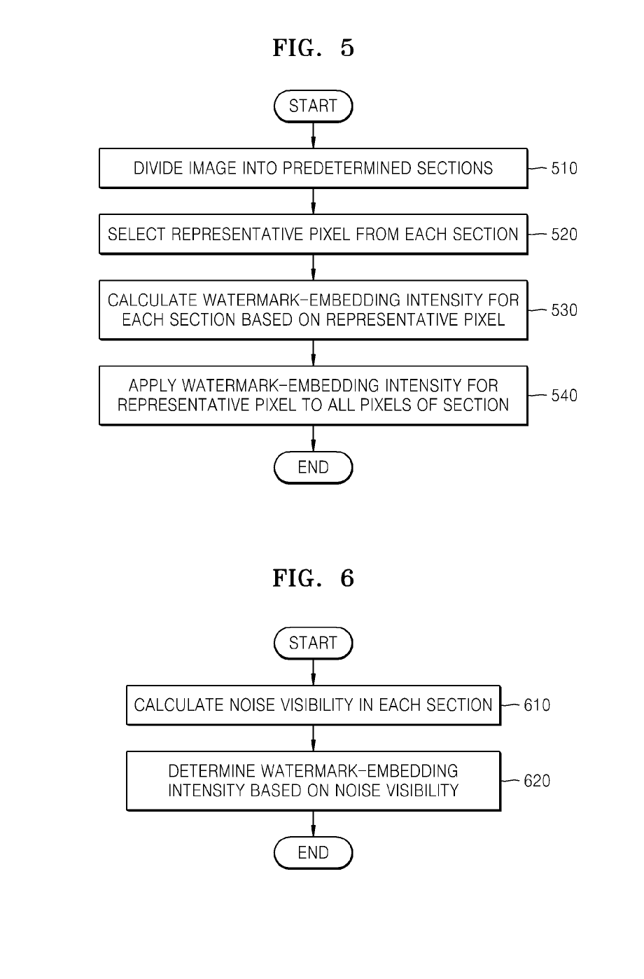

FIG. 5 is a detailed flowchart illustrating the operation of determining a watermark-embedding intensity, illustrated in FIG. 4.

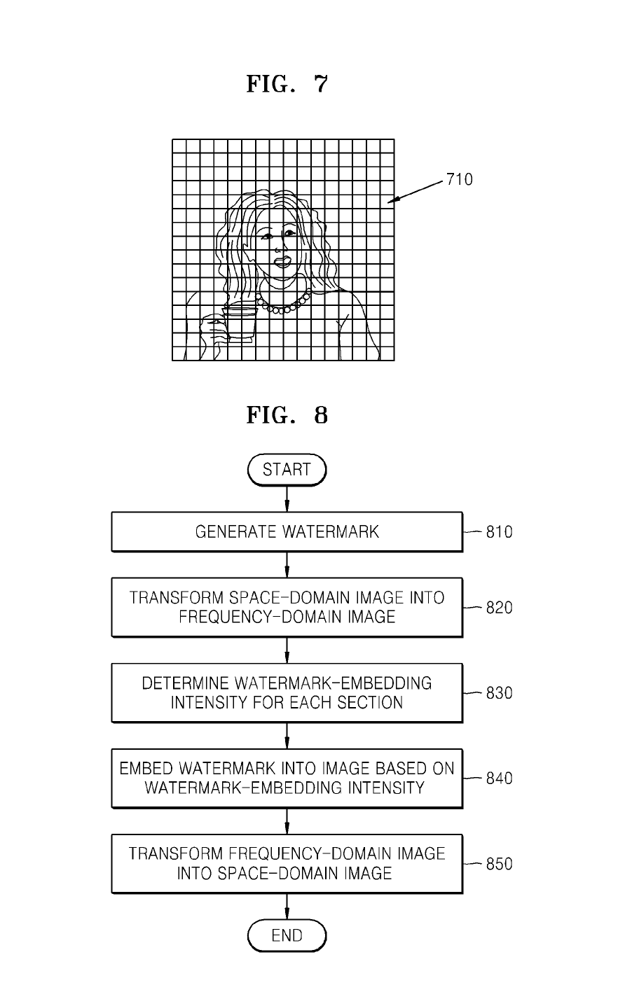

In operation 510, an image into which a watermark is to be embedded is divided into predetermined sections as shown in FIG. 7. The sections may be in various forms, e.g., uniform blocks as shown in FIG. 7 or non-uniform blocks.

In operation 520, a representative pixel is selected from each of the sections. In an exemplary embodiment, a pixel located at the center of each section may be selected as a representative pixel, pixels adjacent to the pixel located at the center of the section may be selected as representative pixels, pixels located at random in the section may be selected as representative pixels, or pixels located at predetermined intervals may be selected as representative pixels.

In operation 530, a watermark-embedding intensity of each section is calculated based on the selected representative pixel of each section.

In operation 540, the calculated watermark-embedding intensity for the representative pixel of each section is applied to all pixels of the section based on the similarity between adjacent pixels in the section, thereby setting a watermark-embedding intensity for each of the sections.

Thus, the image into which the watermark is embedded can be expressed as follows:

Y(i, j)=X(i, j)+λ(k)*W(i, j) (2),

where (i, j) indicates a position of a pixel, k indicates a position of a section in which the (i, j)^{th} pixel is included, and λ(k) indicates a watermark-embedding intensity calculated by using some of the pixels included in the section (k).

FIG. 6 is a detailed flowchart illustrating the operation of calculating a watermark-embedding intensity for each section, illustrated in FIG. 5.

Generally, human eyes are more sensitive to noise in a dark image region than in a bright image region. Thus, when noise is added to the dark image region, human eyes perceive the noise more sensitively.

Moreover, human eyes react more sensitively to a change in red or green than to a change in blue and perceive noise more sensitively in a simple region than in a complex region.

Thus, a watermark-embedding intensity is calculated in various ways according to image characteristics.

Referring to FIG. 6, in operation 610, a noise visibility function (NVF) in a corresponding section is obtained by using a local distribution σ²(i, j) of pixels adjacent to a particular pixel of the section.

A Noise Visibility Function (NVF) in a particular pixel position (i, j) can be expressed as follows:

NVF(i, j)=1/(1+σ²(i, j)) (3).

In Equation 3, a visibility of noise increases with an NVF. Thus, a watermark-embedding intensity may be controlled such that a watermark is embedded with a low embedding intensity for a high NVF.

For example, a watermark may be embedded into an image as in Equation 4 by using an NVF.

Y(i, j)=X(i, j)+(1−NVF(i, j))*W(i, j) (4),

where Y(i, j) indicates an image into which a watermark is embedded, X(i, j) indicates an original image, and W(i, j) indicates a watermark signal.

In the exemplary embodiment, an NVF is not calculated for each pixel. Instead, some pixels are selected from each section as shown in FIG. 7, an NVF of each section is calculated by using a distribution of the selected pixels, and the calculated NVF is applied to all pixels of each section, thereby embedding a watermark.

For example, an NVF in a k^{th} section 710 of an image can be calculated as follows:

NVF(k)=1/(1+λ²(k)) (5),

where σ²(k) indicates a local distribution calculated by using some pixels of the k^{th} section 710.

Herein, pixels used to calculate a local distribution can be selected from a particular section of an image in various ways.

For example, a local distribution may be calculated by using a pixel located at the center of each section, pixels adjacent to the pixel located at the center, pixels located at random in the section, or pixels located at predetermined intervals.

In operation 620, the watermark-embedding intensity λ(k) in Equation 2 is determined based on the visibility of noise. That is, the watermark-embedded image can be expressed as follows:

Y(i, j)=X(i, j)+(1−NVF(k))*W(i, j) (6),

where k indicates an index of a section including an (i, j)^{th} pixel.

Although the visibility of noise is obtained by using a distribution of an image in an exemplary embodiment of the present invention, various factors such as the brightness or color of the image may be used in another embodiment of the present invention.

Thus, in Equation 2, λ(k) may be calculated based on the levels of brightness or colors of a particular pixel included in the section (k) and pixels adjacent to the particular pixel.

FIG. 8 is a flowchart illustrating a method of embedding a watermark according to another exemplary embodiment of the present invention.

In operation 810, a watermark pattern indicating information associated with an image or reproduction thereof is determined and converted into image data, thereby generating watermark data.

In operation 820, a space-domain image into which a watermark is to be embedded is transformed into a frequency-domain image. For example, the space-domain image may be transformed into a frequency-domain image through a discrete cosine transform (DST), a discrete Fourier transform (DFT), or a wavelet transform.

In operation 830, image coefficients obtained by the transformation are divided into predetermined sections, and image coefficient characteristics are analyzed for each of the sections to determine a watermark-embedding intensity for each of the sections.

In operation 840, the watermark data is embedded into the image coefficients of each section based on the determined watermark-embedding intensity.

In operation 850, the watermark-embedded frequency-domain image is transformed into a space-domain image through an inverse discrete cosine transform (IDCT) or an inverse discrete Fourier transform (IDFT).

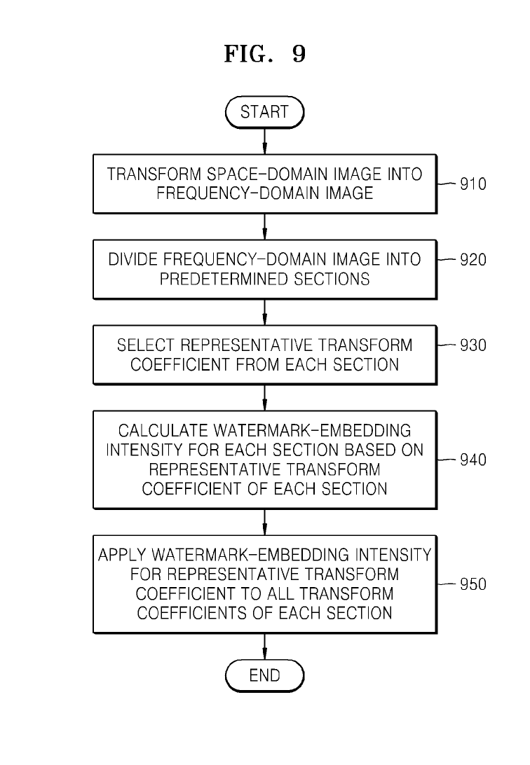

FIG. 9 is a detailed flowchart illustrating the operation of determining a watermark-embedding intensity, illustrated in FIG. 8.

In operation 920, the space-domain image is transformed into frequency-domain image coefficients through a DCT or a DFT.

In operation 920, the frequency-domain image coefficients are divided into predetermined sections.

In operation 930, a representative transform coefficient is selected from each of the sections.

In operation 940, a watermark-embedding intensity for each section is calculated based on the representative transform coefficient.

In operation 950, the calculated watermark-embedding intensity for each section is applied to all coefficients of each section.

The watermark-embedded coefficient can be expressed as follows:

Y^{T}(i, j)=X^{T}(i, j)+λ(k)*W(i, j) (7),

where X^{T} indicates a transform coefficient of an original image, Y^{T} indicates a transform coefficient of a watermark-embedded image, (i, j) indicates a position of a transform coefficient in a transform domain, and W(i, j) indicates a watermark signal. λ(k) indicates a watermark-embedding intensity calculated by using some transform coefficients in a section (k) including a transform coefficient having the position (i, j). λ(k) may be calculated by using the frequency sensitivity or the brightness sensitivity of some transform coefficients included in the section (k).

The present invention can be exemplarily embodied as computer-readable code on a computer-readable recording medium. The computer-readable recording medium is a data storage device that can store data which can be thereafter read by a computer system. Examples of computer-readable recording media include read-only memory (ROM), random-access memory (RAM), CD-ROMs, magnetic tapes, floppy disks, optical data storage devices, etc. The computer-readable recording medium can also be distributed over a network of coupled computer systems so that the computer-readable code is stored and executed in a decentralized fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. Accordingly, the scope of the present invention should be construed to include various embodiments within a scope equivalent to that of claims, without being limited to the disclosed embodiments.

What is claimed is:

1. A method of embedding a watermark, the method comprising:
dividing an image into a plurality of sections;
determining a watermark-embedding intensity for a pixel of each of the sections;
setting a watermark-embedding intensity for each of the sections by applying the determined watermark-embedding intensity for the particular pixel of each of the sections to all pixels of each of the sections; and
embedding the watermark into the image according to the watermark-embedding intensity which is set for each of the sections.

2. The method of claim 1, wherein the determining the watermark-embedding intensity for the particular pixel of each of the sections comprises selecting the particular pixel from each of the sections to calculate the watermark-embedding intensity for the particular pixel of each of the sections, and determining the determined watermark-embedding intensity for the particular pixel as a watermark-embedding intensity for all pixels of each of the sections.

3. The method of claim 2, wherein the determining the watermark-embedding intensity for the particular pixel of each of the sections comprises determining the watermark-embedding intensity for the particular pixel of each of the sections as a watermark-embedding intensity for all pixels of the each of the sections based on a similarity between adjacent pixels in each of the sections.

4. The method of claim 2, wherein the calculating the watermark-embedding intensity for the particular pixel of each of the sections comprises analyzing image characteristics by using a pixel located at the center of each of the sections or pixels adjacent to the pixel located at the center of each of the sections and determining the watermark-embedding intensity according to the analyzed image characteristics.

5. The method of claim 2, wherein the calculating the watermark-embedding intensity for the particular pixel of each of the sections comprises calculating the watermark-embedding intensity for the pixel of each of the sections by using image complexity of the pixel of each of the sections.

6. The method of claim 2, wherein the calculating the watermark-embedding intensity for the particular pixel of each of the sections comprises measuring a noise visibility of each of the sections by using the particular pixel of each of the sections and pixels adjacent to the particular pixel, and controlling the watermark-embedding intensity of each of the sections according to the measured noise visibility.

7. The method of claim 6, wherein the measuring the noise visibility comprises measuring the noise visibility of each of the sections based on a local distribution of the particular pixel and the pixels adjacent to the particular pixel.

8. The method of claim 6, wherein the measuring the noise visibility comprises measuring the noise visibility of each of the sections based on the levels of brightness of the particular pixel and the pixels adjacent to the particular pixel.

9. A method of embedding a watermark, the method comprising:
transforming a spatial-domain image into frequency-domain image coefficients;
dividing the frequency-domain image coefficients into sections;
determining a watermark-embedding intensity for a particular transform coefficient of each of the sections;
applying the determined watermark-embedding intensity for the particular transform coefficient to all transform coefficients of each of the sections;
embedding the watermark into the frequency-domain image coefficients according to the determined watermark-embedding intensity; and
transforming the frequency-domain image coefficients into the spatial-domain image.

10. An apparatus for embedding a watermark, the apparatus comprising:
an image input unit which receives an image into which a watermark is to be embedded;
a watermark-embedding intensity determining unit which divides the image input by the image received unit into a plurality of sections determines a watermark-embedding intensity for a particular pixel of each of the sections, and sets a watermark-embedding intensity for each of the sections by applying the determined watermark-embedding intensity for the particular pixel of each of the sections to all pixels of each of the sections; and
a watermark embedding unit which embeds watermark data of which the embedding intensity is controlled according to the watermark-embedding intensity which is set for each of the sections by the watermark-embedding intensity determining unit into the image.

11. The apparatus of claim 10, wherein the watermark-embedding intensity determining unit comprises:
an image section dividing unit which divides the image into the sections;
an image section analyzing unit which analyzes image characteristics of each of the sections obtained by the image section dividing unit; and
a watermark-embedding intensity extracting unit which extracts a watermark-embedding intensity for each of the sections based on the image characteristics analyzed by the image section analyzing unit and a similarity between adjacent pixels.

12. The apparatus of claim 10, wherein the watermark-embedding intensity determining unit determines the watermark-embedding intensity for the particular pixel calculated for each of the sections based on a similarity between adjacent pixels in each of the sections as the watermark-embedding intensity for all pixels of each of the sections.

13. The apparatus of claim 12, wherein the watermark-embedding intensity determining unit calculates the watermark-embedding intensity for the particular pixel of each of the sections by measuring a noise visibility of each of the sections by using the particular pixel of each of the sections and pixels adjacent to the particular pixel, and controls the watermark-embedding intensity of each of the sections according to the measured noise visibility.

14. The apparatus of claim 13, wherein the watermark-embedding intensity determining unit measures the noise visibility of each of the sections based on a local distribution of the particular pixel and the pixels adjacent to the particular pixel.

15. A computer-readable recording medium having recorded thereon a program for executing a method of embedding a watermark, the method including:
dividing an image into a plurality of sections;
determining a watermark-embedding intensity for a pixel of each of the sections;
applying the determined watermark-embedding intensity for the particular pixel of each of the sections to all pixels of each of the sections; and
embedding the watermark into the image according to the watermark-embedding intensity which is set for each of the sections.

16. A method of embedding a watermark, the method comprising:
generating watermark data by converting a watermark pattern indicating information associated with an input image into an image data format;
determining the watermark-embedding intensity for at least one pixel in each of a plurality of sections of the input image and applying the intensity determined for the at least one pixel in each of the plurality of sections to the remaining pixels in each of the plurality of sections; and
embedding the watermark data into the input image based on the watermark-embedding intensity for each of the plurality of sections.

17. An apparatus for embedding a watermark, the apparatus comprising:
a watermark generating unit which generates watermark data based information associated with an input image;
a watermark-embedding intensity unit which divides an input image into a plurality of sections, determines a watermark-embedding intensity for at least one pixel in each of the plurality of sections, and applies the intensity determined for the at least one pixel in each of the plurality of sections to the remaining pixels in each of the plurality of sections; and
a watermark embedding unit which embeds the watermark data according to the determined watermark-embedding intensity into the input image.
